(19) United States
(12) Patent Application Publication
(10) Pub. No.: US 2017/0273325 A1
(43) Pub. Date: Sep. 28, 2017

(54) Counter-Top Produce Storage Chamber

(71) Applicant: Vincent Arrigo, Sarasota, FL (US)

(72) Inventor: Vincent Arrigo, Sarasota, FL (US)

(21) Appl. No.: 15/618,649

(22) Filed: Jun. 9, 2017

Related U.S. Application Data
(63) Continuation-in-part of application No. 13/894,594, filed on May 15, 2013, now abandoned.
Application No. 13/894,594 is a continuation-in-part of application No. PCT/US2013/025151, filed on Feb. 7, 2013.
Application No. PCT/US2013/025151 is a continuation-in-part of application No. 13/368,195, filed on Feb. 7, 2012, now abandoned.
Application No. 13/368,195 is a continuation-in-part of application No. 13/013,327, filed on Jan. 25, 2011, now abandoned.

(51) Int. Cl. A23B 7/148; A23L 3/3418; F25B 21/02; F25D 11/00; F25D 17/04

(52) U.S. Cl. CPC A23B 7/148; F25D 11/00; F25D 17/042; F25B 21/02; A23L 3/3418; F25D 2317/0416; F25D 2317/0417; F25D 2317/041; F25D 2317/04131; A23V 2002/00

(57) ABSTRACT

A produce storage chamber designed to fit on a counter top. The produce storage chamber capable of encasing produce, a refrigeration system, at least one ozone generation unit, and at least one ethylene scrubber. The chamber is capable of delaying postharvest produce deterioration using temperature control, ozone generation, and ethylene scrubbing.

### CROSS-REFERENCE TO RELATED APPLICATION

This application is a Continuation-in-Part of U.S. patent application Ser. No. 13/894,594, filed May 15, 2013, which is a Continuation-in-Part of International Application No. PCT/US2013/25151, filed Feb. 7, 2013, which is a Continuation-in-Part of U.S. patent application Ser. No. 13/368,195, filed Feb. 7, 2012, Continuation-in-Part of U.S. patent application Ser. No. 13/013,327, filed Jan. 25, 2011, the disclosure of which is hereby incorporated by reference.

### FIELD

The present invention relates to the field of produce storage. More specifically, to a produce storage chamber designed to reduce spoilage and fit on a counter top.

### BACKGROUND

Due to various nutrient and antioxidant profiles, consumption of fresh produce is generally accepted as essential to a healthy diet. Regular consumption of fruit is associated with reduced risks of cancer, cardiovascular disease (especially coronary heart disease), stroke, Alzheimer's disease, cataracts, and some of the general functional declines associated with aging. Diets that include a sufficient amount of fruits and vegetables also help reduce the chance of developing kidney stones and may help reduce the effects of bone loss. Fruits are also low in calories and are often integral to weight loss plans and generally healthy, balanced diets.

Most fruits and vegetables ripen after they are removed from their associated plants and stalks. Such ripening often changes the characteristics of the produce, including altering sweetness levels, texture, and firmness. Consumption of fruits and vegetables at the optimal point in the ripening process helps maximize not only taste and enjoyment of these foods, but may also maximize their health benefits.

Ripening is a natural process which is primarily a result of the production of ripening enzymes, many of which are triggered by the release of ethylene by the produce. Ethylene is a simple hydrocarbon gas produced when a fruit ripens, and is known to promote the upregulation of genes that cause the expression of enzymes that foster ripening. These enzymes may change the color of the skin as chlorophyll is degraded, aid in the production of new pigments, foster the breakdown of acids that make fruit taste sour, convert starches into sweet sugars, and soften pectin.

Some fresh fruits continue to ripen after they have been harvested while others do not. Whether or not a fruit continues to ripen is a key factor in determining its storage and shelf life. Fruits that require additional ripening should be stored at room temperature until they become ripe. Fruits that do not ripen after harvesting should be stored in a cool are until they are used.

While ethylene is great for ripening some fruits, the gas can cause premature decay of other fruits and vegetables that are sensitive to it. To avoid deterioration or rapid ripening of sensitive commodities, avoid holding them in the same storage room or refrigerator compartment with products that emit a great deal of ethylene gas. Diseased or injured fruits generate substantially increased levels of ethylene.

Fruits that ripen after harvest include: apricots, avocados, bananas, cantaloupe, honeydew, kiwi, nectarines, papaya, peaches, pears, plantains, plums, and tomatoes.

Fruits that produce larger amounts of ethylene include: apples, apricots, avocados, cantaloupe, honeydew, kiwi, mangos, papayas, peaches, pears, and plums.

Maintaining most fruits and vegetables in a sufficiently cold state after harvest helps extend and ensure shelf life, most notably by reducing the release of ethylene. However, storage of produce in an isolated area without refrigeration causes a buildup of ethylene and results in faster ripening (and rotting) of fruits and vegetable. Generally, for every ten degrees Fahrenheit above ideal storage temperature, a produce item will lost half of its life expectancy.

Ozone is a pungent, naturally-occurring gas possessing strong oxidizing properties, and has a long history of safe use in the disinfection of water sources. Ozone rapidly attacks bacterial cell walls and is generally thought to be a more effective anti-pathogenic agent against plant spores and mammalian parasites than chlorine. Ozone is reported to have 1.5 times the oxidizing potential of chlorine, yet contact times for this antimicrobial action are typically 4-5 times less than that of chlorine, all without the unwanted byproducts associated with chlorine. Ozone is also known to degrade ethylene.

What is needed is an energy efficient and robust chamber for use with fresh fruits and vegetables.

### SUMMARY

The present invention provides a table top, stackable produce chamber comprising a chamber capable of encasing produce, having a refrigeration system, at least one ozone generation unit, and at least one ethylene scrubber. The chamber is therefore capable of delaying postharvest produce deterioration using temperature control, ozone generation, and ethylene scrubbing.

In one embodiment, the present invention contemplates a portable produce chamber comprising a housing having a size and dimension to fit on a kitchen countertop, the housing comprising a chamber capable of encasing produce. In one embodiment, the chamber is shaped so that one chamber will securely stack on another chamber of the same type. At least one ethylene scrubber is fitted within the chamber capable of reducing chamber ethylene gas concentrations to delay postharvest produce deterioration. The chamber is in communication with a refrigeration system for the purpose of maintaining a chamber temperature that delays postharvest produce deterioration. Additionally, the refrigeration system maintains a chamber relative humidity that delays postharvest produce deterioration. Lastly, an ozone generator in communication with the chamber maintains a chamber ozone concentration for the purpose of delaying postharvest produce deterioration.

The invention also contemplates a method of reducing postharvest produce deterioration comprising the steps of: placing produce in a chamber; encasing the produce within the chamber; cooling the chamber to a temperature from about 10° C. to 20° C.; introducing gaseous ozone into the chamber to maintain a chamber ozone concentration between approximately 0.005 ppm and approximately 0.35 ppm; and maintaining a relative humidity within the chamber ranging from about 70% to 100% relative humidity.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a perspective view of the produce chamber;

FIG. 2 is a right side perspective view of the produce chamber;

FIG. 3 is a left side view of the produce chamber;

FIG. 4 is front view of the produce chamber;

FIG. 5 is an exploded view of the components of the produce chamber;

FIG. 6 is a perspective view of the refrigeration system within the produce chamber; and

FIG. 7 illustrates the preferred thermoelectric plate (TE) used within the produce chamber.

### DETAILED DESCRIPTION

In the Summary of the Invention above and in the Detailed Description of the Invention and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, the present invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art.

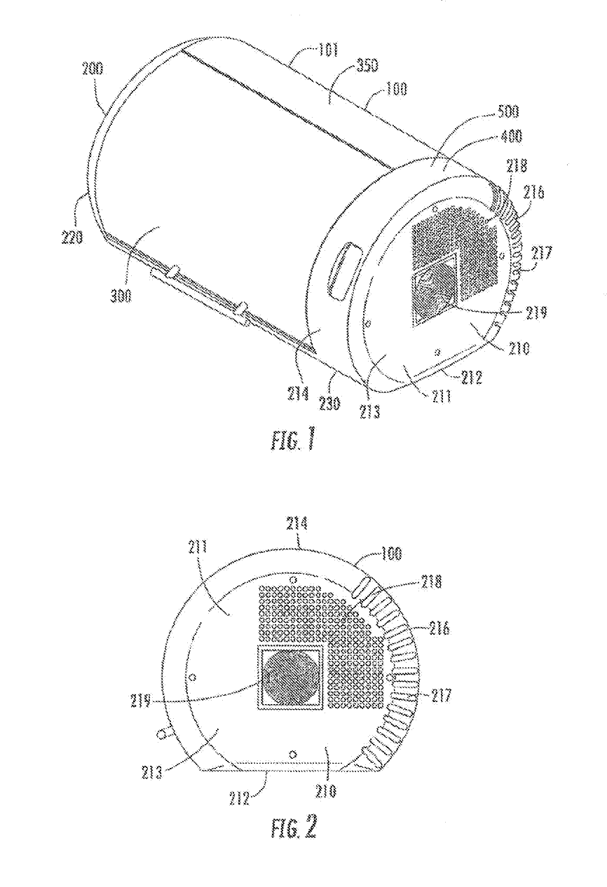

As illustrated in FIGS. 1 through 6, the invention is directed to a produce chamber 100 used to store fruits, vegetables, and other perishable foods to ensure ripeness. The produce chamber 100 helps regulate the temperature and humidity of fruits and vegetables and to ensure regulated and reduced levels of ethylene. In doing so, the produce chamber 100 helps maintain the proper ripeness of produce stored within its confines. While the invention contemplates a design for use on a kitchen countertop, the underlying technology can be used in related units, including produce chambers 100 that are stackable (i.e., for use as displays at grocers to maintain fruits and vegetables), and produce chamber 100 that are equal in size to current grocery store refrigeration units.

As shown in FIG. 1-5, the components 101 of the produce chamber 100 comprises an outer housing 200, a door 300 maintained by the outer housing 200, a refrigeration system 400, and a controller 500 to help regulate temperature, humidity, ozone, and ethylene concentration. In addition, the invention contemplates placement of a series of perforated trays 600 and a produce hook 630 within the outer housing 200 which help hold and maintain the stored produce. Other additional and related components will be known and understood by those of ordinary still in the art upon review of the figures and this disclosure.

### The Outer Housing

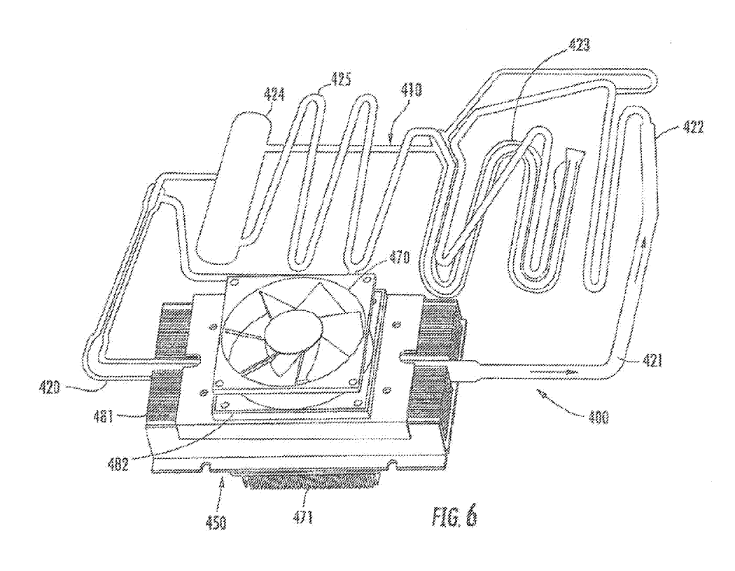

FIGS. 1 through 5 illustrate, by way of example, one embodiment contemplated by the invention for the outer housing 200. First turning to FIG. 1, the outer housing 200 may include a first side panel 210, a second side panel 220 and a base plate 230 (shown in greater detail in FIG. 5). The side panels 210 and 220 are essentially parallel to one another in order to form two respective ends of the produce chamber 100. The base plate 230 is interdispersed between both side panels 210 and 220. Combination of these panels 210 and 220, as well as the base plate 230 function as the outer casing of the outer housing 200. This provides a rigid shell for the outer housing 200 in order to protect the integrity of the stored fruits and vegetables. What is more, such rigid shell further serves as a platform in which the various interior components 101 (shown in FIG. 5) are maintained and held within the produce chamber 100.

FIG. 2 further illustrates one preferred shape, structure, and configuration for the first side panel 210. The first side panel 210 not only functions as part of the rigid outer housing 200, but also maintains two primary components of the produce chamber 100. As shown in FIG. 2 (as well as FIG. 5), the first side panel 210 has a sufficient shape to house both the refrigeration system 400 and controller 500. The first side panel 210 further allows for the separation of the cold and hot sides of the refrigeration system 400 as well as to cool the various components housed by the first side panel 210. Moreover, this allows circulation of cooled, ozonated, and humidity controlled air inside the produce chamber 100 for purposes of removing ethylene and inhibiting microbe proliferation.

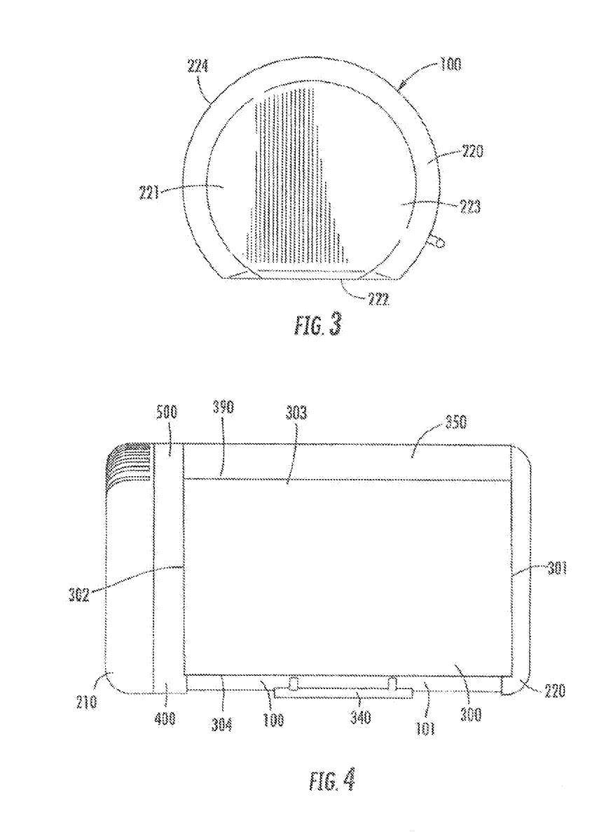

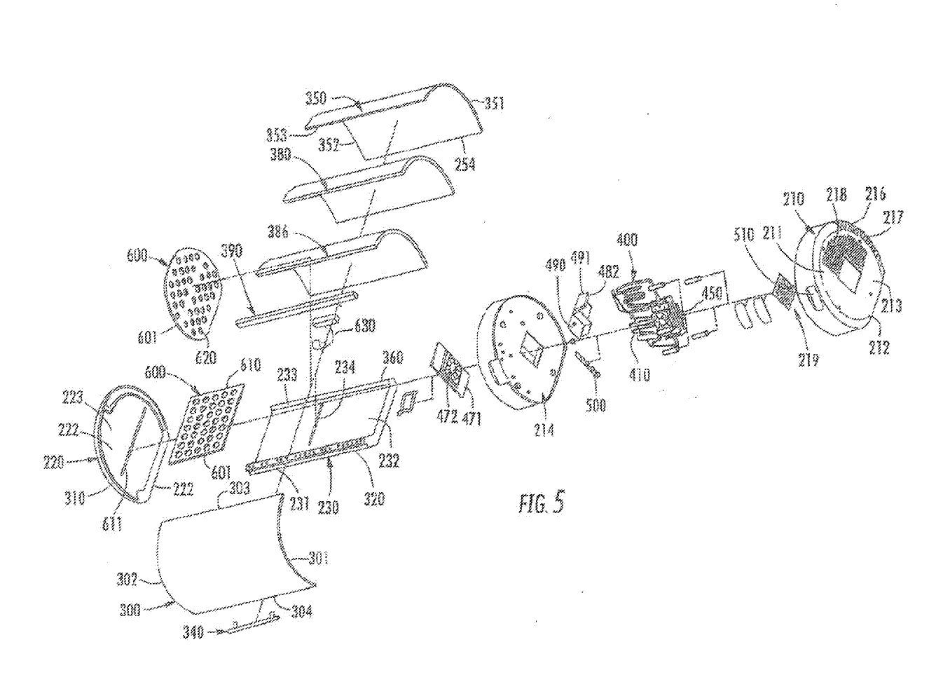

As shown in both FIG. 1 and FIG. 2, the first side panel 210 is preferably a circular disk 211 having an essentially flat bottom portion 212. The bottom portion 212 illustrated in FIG. 2, mirrors the width of the base plate 230 (shown in FIG. 4). As also shown in FIG. 5, the base plate 230 perpendicularly engages the first flat wall 213 of the first side panel 210. This allows the bottom portion 212, and accordingly the entire produce chamber 100, to rest on a flat surface like a kitchen countertop—or alternatively a display counter (such as in a grocery store). Of course other shapes, such as substantially rectangular produce chamber 100 are also contemplated by this disclosure.

Turning back to FIG. 1 (and also to FIG. 4), the structure of the first side panel 210 also includes an isolation plate 214 (in addition to the first flat wall 213 and the bottom portion 212). The isolation plate 214 is essentially circular, conforming to the shape of the bottom portion 212. Moreover, the isolation plate 214 has a sufficient wall thickness so as to house and maintain the various components 101 which may include both the refrigeration system 400 and the controller 500 in a separate compartment from the main produce-storing chamber of the produce chamber 100.

As shown in both FIG. 1 and FIG. 2, both the first flat wall 213 and the isolation plate 214 may include a series of vents 216. As shown, these vents 216 preferably include a side vent 217, a panel vent 218 and a fan vent 219. As shown in greater detail in FIG. 5, the primary function of the side vent 217 and the panel vent 218 is to allow the hot side heat sink fan 482 (shown in FIG. 7) to pull ambient air in through the side vent 217 and the panel vent 218, move it across the hot side heat sink 481 and then push the now hot air out through fan vent 219 so as to remove heat from the refrigeration system 400. The secondary purpose is to pull ambient air in through the side vent 217 and panel vent 218 to cool the controller 500.

Both FIG. 3 and FIG. 5 illustrate, by way of example, the structure, positioning and features of the second side panel 220. As shown, the second side panel 220 mirrors the size and dimension of the first side panel 210. Furthermore, the second side panel 220 comprises a circular disk 221 having a second flat wall 223, a second flat bottom portion 222, and a second ring 224 of similar construction compared to the first side panel 210. Such bottom portion 222 mirrors the width of the base plate 230 (again shown in FIG. 1 and FIG. 5).

FIG. 5 illustrates, by way of example, the structure and features of the base plate 230. As shown, the base plate 230 preferably includes a front raised edge 231, a bottom panel 232, a back raised edge 233, and a divider groove 234. The front raised edge 231 helps engage and create a sealing relationship with the door 300. Similarly, the back raised edge 233 both meets and connects to the back panel 350. The divider groove 235 is a slit that has a sufficient length and depth so as to engage and maintain at least one perforated tray 600.

### The Door and Back Panel

Both FIG. 4 and FIG. 5 illustrate, by way of example, the structure and characteristics of both the door 300 (which optionally may be translucent) and the back panel 350 which, along with the outer housing 200, form the exterior of the produce chamber 100.

First turning to FIG. 4, the door 300 includes a first edge 301, a second edge 302, a top edge 303, and a bottom edge 304. Moreover, at least a portion of the door 300 is preferably transparent and accordingly see through—such that a user may be able to view the condition and quantity of fruits and vegetables within the produce chamber 100. Preferably, a handle 340 is positioned proximate the bottom edge 304 of the door 300. The handle 340 helps make it easier to lift up and open the door 300 to retrieve (or alternatively store) produce.

As shown in FIG. 5, the first edge 301 of the door 300 is preferably arced. This curvature should be substantially the same as that of the isolation plate 214 of the first side panel 210. Likewise, the second edge 302 should have curve that mirrors that of the second ring 224 of the second side panel 220. Accordingly, when the door 300 is shut, a seal 310 forms between the first edge 301 and the isolation plate 214 (and correspondingly, the second edge 302 and the second ring 224). In addition, the bottom edge 304 forms a bottom seal 320 with the front raised edge 231 of the base plate 230.

FIG. 1-5 further illustrates, by way of example, the salient components 101 of the back panel 350. As shown, the back panel 350 includes a first edge 351, a corresponding second edge 352, a top edge 353, and a bottom edge 354. The first edge 351 is sufficiently curved to match the shape of the first side panel 210, while the second edge 352 is likewise arced to mirror the diameter of the second side panel 220. As further shown, the bottom edge 354 forms a bottom seal 360 with the back raised edge 233 of the bottom plate 230.

A top hinge 390 connects the top edge 301 of the door 300 with the top edge 351 of the back panel 350. As shown, the top hinge 390 allows the door 300 to swivel open and allow access the various fruits and vegetables within the produce chamber 100. Optionally, the back panel 350 may include an insulating layer 380. This insulating layer can be sandwiched between the back panel 350 and an interior panel 385. Such insulating layer 380 increases the efficiency of the system and reduces the need for the refrigeration system 400 to constantly run to provide cooled air within the produce chamber 100.

### Perforated Trays

FIG. 5 further illustrates, by way of example, the positioning and orientation of the perforated trays 600 within the produce chamber 100. As shown, the perforated trays 600 preferably include a horizontal tray 610 and a corresponding vertical tray 620. Both trays 610 and 620 include a plurality of holes 601 to allow air to circulate. This helps ensure the reduction of ethylene within the produce chamber 100, as well as a regulated internal temperature monitored by the controller 500.

As further shown in FIG. 5, the horizontal tray 610 is maintained through a slit 611 found within the second side panel 220. In contrast, the vertical tray 620 is maintained by both the horizontal tray 610 as well as the divider groove 234 located on the base plate 230.

Optionally, a hook 630 can be affixed to the top hinge 390 sufficient to hold and maintain bananas and similar fruits within the produce chamber 100.

### The Refrigeration System

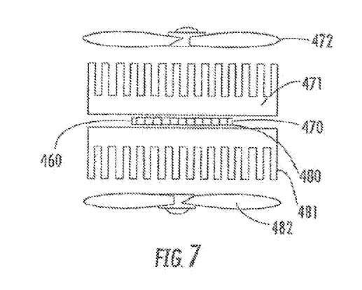

Both FIG. 5 and FIG. 6 illustrate, by way of example, one embodiment of the refrigeration system 400. While several refrigeration systems 400 are capable of being used within the produce chamber 100, the invention contemplates utilization of a cooling means, comprising at least one of an ammonium absorption (AAF) system 410, a Peltier effect thermoelectric (TE) cooling system 450, or a vapor-compression refrigeration (VCR) system (not shown). While FIG. 5 illustrates this two-part refrigeration system 400, the invention also teaches use of just a single AAF system 410 without need for the TE system 450 or use of a single TE system 450 without the need for an AAF system 410, or the use or a single VCR system, or the use of a VCR system combined with a TE 450 or an AAF 410 system.

Both FIG. 5 and FIG. 7 illustrate a TE system 450 generally comprised of a thermoelectric (TE) module 460 which is comprised of a cold side plate 470 and a hot side plate 480 and corresponding cold side heat sink 471 and cold side heat sink fan 472 and hot side heat sink 481 and hot side heat sink fan 482. When electricity is applied to the TE module 460 the cold side plate 470 cools down and the hot side plate 480 heats up. A cold side heat sink 471 is thermally coupled to the cold side plate 470 which allows heat to be efficiently transferred from the inside of the produce chamber 100 to the cold side plate 470. A cold side heat sink fan 472 increases the efficiency of the entire system. The cold side heat sink fan 472 also works to keep the air within the produce chamber 100 moving through the zeolite filter 491. As further illustrated by FIG. 7, heat absorbed by the cold side plate 470 is transferred to the hot side plate 480. This heat is transferred through the thermally coupled hot side heat sink 481 which located outside of the produce chamber 100. The hot side heat sink fan 482 is used to efficiently remove the heat from the hot side heat sink 481. This heat is vented out through the fan vent 219 FIG. 5 illustrates an AAF system 410 comprised of a boiler 420, ammonia 421, a condenser 422, an evaporator 423, a storage tank 424, and an absorber 425. A concentrated ammonia solution 421 is heated in the boiler 420 and driven off as vapor. The pressurized ammonia 421 gas is then liquefied in a condenser 422. Supplied with hydrogen, it evaporates in the evaporator 423 and extracts heat from the storage container 424. The ammonia 421 gas then enters the absorber 425 where it is reabsorbed in a weak solution of ammonia 421. Finally, the saturated solution flows back to the boiler 420 where the whole cycle starts again.

FIG. 6 illustrates one arrangement for the various components 101 of the two-part refrigeration system. Since the TE system 450 cools the produce chamber 100 by extracting heat from it. This heat must ultimately be removed from the entire produce chamber 100. In turn, the AAF system 410 starts by heating ammonia 421 in the boiler 420.

The boiler 420 can be heated by any number of means; all that matters is that heat is provided to the boiler 420. The invention specifically contemplates combination of both a TE system 450 and an AAF system 410, wherein the heat from the TE system 450 hot side heat sink 481, (which is normally wasted energy that must be removed from the produce chamber 100), be used to heat the AAF system 410 boiler 420. By using what would normally be wasted heat from the TE system 450 to drive the AAF system 410, the overall efficiency of the produce chamber 100 is dramatically increased.

### The Controller and Scrubber

The controller 500 is best illustrated in FIG. 5. There are three primary functions of the controller 500 contemplated by the invention. First, the controller 500 constantly monitors the temperature and humidity within the produce chamber 100. Such information may be displayed by a digital readout 510 positioned and located on the first side panel 210. Second, the controller 500 operates the refrigeration system 400. Such operation may include determining when to turn on the AAF system 410 and/or the TE system 450.

As a third duty, the controller 500 can also opt to circulate already cooled air within the produce chamber through a scrubber 490 for purposes of removing toxins such as ethylene which may lead to premature ripening of the fruits and vegetables contained within the produce chamber 100.

### Ethylene Scrubbing

To foster ethylene removal from the produce chamber 100, media for the purpose of scrubbing ethylene from the air is present in the produce chamber 100. The media is at least one of activated alumina, vermiculite, zeolite, and silica gel. The media is impregnated with potassium permanganate (KMn04). The mass of media utilized is tailored to the size of the produce chamber 100. Media pore size, pore volume, surface area, and bulk density is also tailored to the size of the produce chamber 100. Media with lower bulk density is desired over the same mass of media possessing a higher bulk density, due to the greater surface area of the lower bulk density media providing greater availability of KMn04 to ethylene gas. The mass, pore size, pore volume, surface area, and bulk density required for the produce chamber 100 will be readily apparent to those skilled in the art. The media performs two primary functions: (1) to provide an absorptive surface to trap ethylene gas molecules, and (2) to provide a substrate on which KMn04 is carried. KMn04 is an oxidizing agent that reacts with ethylene, oxidizing it to ethylene glycol which does not markedly affect produce ripening. The produce chamber 100, in a preferred embodiment, comprises at least one sachet containing 5 mg KMn04 impregnated zeolite. Besides or in conjunction with sachets, KMn04 impregnated filters and pellets may be used in the chamber 100.

In another embodiment, ultraviolet light mediated photcatalysis of titanium oxide reduces ethylene levels in the produce chamber 100 (the ultraviolet light source is optically sequestered from the produce). In one embodiment of the produce chamber 100, at least one dedicated pocket, bag, shelf, hook, or net provides a location for at least one sachet containing ethylene scrubbing media.

Titanium dioxide is known to be a photocatalyst under ultraviolet (UV) light. When Titanium dioxide is spiked with nitrogen ions or doped with metal oxide like tungsten trioxide, it is also a photocatalyst under either visible or UV light. The titanium dioxide photocatalytic reaction breaks down ethylene gas into carbon dioxide and water vapor. Additionally, photocatalytic oxidation provides the added benefit of reducing bacteria, molds, and odors. In one embodiment of the invention, a titanium dioxide photocatalyst is in communication with the produce chamber 100 for the purpose of scrubbing ethylene gas and preventing the premature ripening and spoiling of the fruits and vegetables contained within the produce chamber 100.

### Ozone Generation

Ozone cannot be stored and transported like most other industrial gases, so must therefore be locally produced. Ozone can be produced in a number of ways known in the art. The most common methods are by the use of ultraviolet light and coronal discharge.

In one embodiment of the invention ozone is generated with an ultraviolet (UV) lamp. A UV lamp emitting light at approximately 185 nm in the presences of air (which is approximately 21% oxygen) will cause some diatomic oxygen (O₂) molecules to split, resulting in single oxygen atoms (O⁻) that bind to other diatomic oxygen molecules to form ozone (O₃). UV mediated ozone generation is advantageous in the current invention, for it is not susceptible to nitric oxide formation, as are some corona discharge-based devices operating in a humid environment.

The coronal discharge method of ozone is employed for many industrial and personal uses. While multiple variations of the “hot spark” coronal discharge method of ozone production exist, these units usually work by means of a coronal discharge tube. Coronal discharge tubes are typically cost effective and do not require an oxygen source other than the ambient air to produce ozone. In one embodiment of the invention, ozone is generated with a coronal discharge devise. In such a device, air passed through an electrical field wherein ozone is generated. The preferred embodiment of an ozone generator is a variation of the coronal discharge method.

### Method of Reducing Postharvest Produce Deterioration

The present invention contemplates a method of reducing the severity of postharvest produce deterioration. The method preferably utilizes the produce chamber 100 described herein. The method includes the step of placing of produce in a chamber of a suitable size and dimension to encase the produce. The produce chamber 100 is capable of being substantially sealed. The chamber is cooled to a temperature ranging from 10° C. to 20° C., with the preferred temperature being 13° C. Additionally, ozone is introduced into the chamber so that a chamber ozone concentration is maintained from approximately 0.005 ppm to approximately 0.35 ppm, with a preferred concentration range between approximately 0.05 ppm and approximately 0.15 ppm. A high cutoff point of approximately 0.3 ppm ozone may be maintained to ensure that ozone levels remain below permissible levels as established by Occupational Health and Safety Administration (OSHA) regulations. In a preferred embodiment, the ozone is introduced into the chamber 100 by an ozone generator that is installed within the chamber. In one embodiment, ethylene is scrubbed from the chamber environment. In a preferred embodiment, ethylene concentrations within the chamber remain below 0.015 ppm. Preferably, 5-gram sachets of potassium permanganate are placed within the chamber 100 for the purpose of ethylene scrubbing, though other methods of ethylene scrubbing will be clear to those skilled in the art. The step of maintaining a relative humidity from 70% to 100% within the chamber is also contemplated with a preferred relative humidity level being about 95%. The chamber 100 is placed on a counter top surface, such that as found in a residential or commercial kitchen environment. In an alternative embodiment, one chamber 100 is stacked on another chamber 100 so that multiple chambers form a stacked chamber array.

### Examples and Experimental Data

The following experimental data compared the post-harvest degradation of bananas and tomatoes in various conditions. The control (“room condition”) temperatures ranged from approximately 22° C. to 25° C., while experimental refrigerated temperatures ranged from approximately 12° C. to 15° C. Relative humidity for control groups was maintained at approximately 25% RH to 50% RH, while experimental groups were maintained between approximately 85% RH to 100% RH. Ethylene gas concentrations were maintained in control groups between approximately 0.02 ppm and 0.035 ppm, while some experimental groups were maintained between approximately 0.0 ppm and 0.01 ppm. Ozone was not introduced in control groups, while some experimental groups were maintained between approximately 0.08 ppm and approximately 0.095 ppm ozone, which is within the acceptable level range allowed by the Occupational Safety and Health Administration (OSHA) regulations for such application.

TABLE 1
Moisture Loss per Banana/Tomato (after 21 Days)

| | Banana | | Tomato | |
|---|---|---|---|---|
| | | % Moisture | | % Moisture |
| Storage Condition | Mass | Loss | Mass | Loss |
| Ozone Treated (13° C.) | 18.1 g | 10.5 | 3.4 g | 2.6 |
| Ozone + Ethylene | 12.1 g | 5.3 | 2.1 g | 1.6 |
| Scrubbing (13° C.) | | | | |
| Ambient Room | 86.2 g | 38.4 | 7.2 g | 5.5 |
| Temperature | | | | |

*Note:
The standard error of the mean between treatments for bananas is 27.8 g and for tomatoes is 1.5 g.

Bananas and tomatoes were weighed every 2 days to track moisture loss. Table 1 summarizes the amount of moisture lost per individual banana or tomato for each storage condition. There was only a minimal discrepancy between the amount of moisture lost in the two 13° C. storage treatments. Moisture loss was lower in the treatment with additional ethylene scrubbing for both bananas and tomatoes, but the difference was within the standard error and thus was not statistically significant. However, fruit left exposed to the ambient/room temperature conditions were found to lose much more moisture. From these results, it can be concluded that lower temperatures with higher RH result in improved water retention in these fruit. Furthermore, it is possible that the removal of additional ethylene using ethylene scrubbing sachets may improve the water retention.

TABLE 2
Banana Firmness Evaluated at 6 mm Deformation (Force in kg)

| | | Ozone + Ethylene | Cont (Room |
|---|---|---|---|
| | Ozone (13° C.) | Scrubbing (13° C.) | Temperature) |
| Day 0 | 4.226 | 4.159 | 4.191 |
| Day 6 | 3.522 | 3.772 | 1.973 |
| Day 12 | 3.031 | 3.438 | 1.052 |
| Day 14 | 2.869 | 3.381 | 0.601 |
| Day 16 | 2.972 | 3.656 | 0.391 |
| Day 19 | 2.557 | 3.013 | 0.356 |
| Day 21 | 2.534 | 3.128 | 0.402 |

Table 2 shows that bananas in both of the 13° C. storage treatment exhibited improved preservation of firmness over bananas in ambient/room conditions. This is indicated by higher force values for the bananas stored at 13° C., particularly with the bananas in the ozone with ethylene scrubbing treatment. Thus, the treatment with ozone and ethylene scrubbing provided better preservation of firmness over the treatment with ozone only.

TABLE 3
Tomato Firmness Evaluated at 3 mm Deformation (Force in kg)

| | | Ozone + Ethylene | Cont (Room |
|---|---|---|---|
| | Ozone (13° C.) | Scrubbing (13° C.) | Temperature) |
| Day 0 | 3.004 | 2.988 | 2.959 |
| Day 6 | 2.354 | 2.418 | 1.533 |
| Day 12 | 2.168 | 2.291 | 1.192 |
| Day 14 | 2.187 | 2.197 | 1.207 |
| Day 16 | 2.142 | 1.967 | 1.367 |
| Day 19 | 1.825 | 1.541 | 1.197 |
| Day 21 | 1.619 | 1.468 | 1.082 |

Table 3 shows that tomatoes in the 13° C. storage treatments exhibited improved preservation of firmness compared with tomatoes in the ambient/room temperature treatment. This is indicated by elevated force values for the tomatoes stored in 13° C. storage conditions compared with the lower force values observed with tomatoes stored in the ambient/room conditions. Minimal distinction can be seen between the firmness in tomatoes stored in the ozone treatment and the treatment with ozone and ethylene scrubbing.

Ozone concentration in the 13° C. storage treatments were effectively regulated and maintained within permissible levels as established by OSHA regulations. The presence of ozone in the 13° C. treatments effectively reduced the ethylene concentration by about two-thirds, while the treatment with additional ethylene scrubbing further reduced the ethylene concentration to essentially negligible levels.

The tomatoes and bananas that were held in the ambient/room temperature conditions on the countertop were observed to be exceptionally shriveled and soft after only 6 and 12 days, respectively. Tomatoes in this storage condition were also found to have mold growth after 14 days particularly near the stern end. It was also determined that produce exposed to the ambient/room temperature conditions lost a significant amount of moisture over the 21 day trial. Furthermore, firmness measurements using a Texture Analyzer Plus (Stable Micro Systems) found that both the bananas and tomatoes had severely softened in the room temperature storage condition. Thus, storage in the ambient/room temperature treatment resulted in considerably diminished produce quality.

Bananas and tomatoes held at 13° C. exhibited significantly better maintenance of quality compared with produce stored in the ambient/room temperature conditions. Water retention was further improved in the treatment using ozone with additional ethylene scrubbing. Better color retention was also observed for both the bananas and tomatoes that received ozone with ethylene scrubbing. Greater levels of brown-spotting were observed in the bananas treated with only ozone than those treated with ozone and ethylene scrubbing. Additionally, more extensive shriveling and tearing of tomato flesh was observed with only ozone than with only ozone than with ozone plus ethylene scrubbing. Banana firmness was also best preserved in the fruit stored in the ozone with ethylene scrubbing treatment. Thus, storage at 13° C. using ozone with additional ethylene scrubbing resulted in the highest quality produce.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A counter-top produce storage chamber, the produce storage chamber comprising:
a housing having a substantially sealable interior chamber;
at least one ethylene scrubber;
at least one ozone generator; and
a refrigeration system.

2. The counter-top produce storage chamber of claim 1, wherein the at least one ethylene scrubber comprises a media impregnated with potassium permanganate.

3. The counter-top produce storage chamber of claim 2, wherein the media is selected from the group consisting of: activated alumina, vermiculite, zeolite, and silica gel.

4. The counter-top produce storage chamber of claim 1, wherein the at least one ethylene scrubber comprises an ultraviolet light photocatalyis of titanium dioxide.

5. The counter-top produce storage chamber of claim 1, further comprising a humidity controller, whereby the humidity controller maintains the humidity in the substantially sealable interior chamber between 80 percent and 100 percent.

6. The counter-top produce storage chamber of claim 1, wherein the refrigeration system is selected from the group consisting of: an ammonium absorption system, a Peltier effect thermoelectric cooling system, and a vapor-compression refrigeration system.

7. The counter-top produce storage chamber of claim 1, wherein the at least one ozone generator comprises:
a coronal discharge circuit, the coronal discharge circuit affixed to the substantially sealable interior chamber; and
an ozone level controller in communication with the coronal discharge circuit;
whereby the ozone level controller turns off the coronal discharge circuit in response to ozone levels above 0.15 ppm, and turns on the coronal discharge circuit in response to ozone levels below 0.05 ppm.

8. The counter-top produce storage chamber of claim 1, wherein the the at least one ozone generator comprises:
an ultraviolet light; and
an ozone level controller in communication with the coronal discharge circuit;
whereby the ozone level controller turns off the coronal discharge circuit in response to ozone levels above 0.15 ppm, and turns on the coronal discharge circuit in response to ozone levels below 0.05 ppm.

9. A produce storage device, the produce storage device comprising:
a housing having an interior chamber for storage of produce;
at least one ethylene scrubber;
a coronal discharge circuit, the coronal discharge circuit affixed to the interior chamber; and
an ozone level controller in communication with the coronal discharge circuit;
whereby the ozone level controller turns off the coronal discharge circuit in response to ozone levels above 0.15 ppm, and turns on the coronal discharge circuit in response to ozone levels below 0.05 ppm.

10. The produce storage device according to claim 9, further comprising a heating element, whereby the heating element activates to increase a temperature within the interior chamber when the temperature within the interior chamber falls below the temperature outside the interior chamber.

11. The produce storage device according to claim 9, wherein the ethylene scrubber comprises a media impregnated with potassium permanganate.

12. The produce storage device according to claim 11, wherein the media impregnated with potassium permanganate is selected from the group consisting of alumina, silica gel, vermiculite, and zeolite.

13. The produce storage device according to claim 9, further comprising a humidity controller, whereby the humidity controller maintains humidity in the chamber between 80 percent and 100 percent.

14. A counter-top produce storage chamber, the counter-top produce storage container comprising:
an interior chamber to store produce;
an ultraviolet light source, the ultraviolet light source affixed in the interior chamber; and
a coating of titanium dioxide doped with tungsten trioxide on at least a portion of the interior chamber.

15. The counter-top produce storage chamber of claim 15, whereby the ultraviolet light source:
creates ozone in the interior chamber by reacting with air; and
reacts with the coating of titanium dioxide to break down ethylene gas in the interior chamber.
